(19) United States
(12) Patent Application Publication
(10) Pub. No.: US 2015/0198561 A1
(43) Pub. Date: Jul. 16, 2015

(54) MAGNETIC SENSOR DEVICE

(71) Applicant: Nidec Sankyo Corporation, Suwa-gun, Nagano (JP)

(72) Inventor: Shogo Momose, Suwa-gun (JP)

(21) Appl. No.: 14/414,319

(22) PCT Filed: Jun. 13, 2013
(86) PCT No.: PCT/JP2013/066291

§ 371 Date: Jan. 12, 2015

(30) Foreign Application Priority Data
Jul. 26, 2012 (JP) 2012-165314

(51) Int. Cl. G01N 27/90; G01V 3/10

(52) U.S. Cl. CPC G01N 27/9033; G01V 3/10

(57) ABSTRACT

Provided is a magnetic sensor device that is capable of relaxing a sensitivity change due to the position of a sample to be inspected, even with a configuration wherein the sample to be inspected is disposed on the side of an exciting coil and a detecting coil. Specifically, in a magnetic sensor device, an exciting coil and a detecting coil are disposed with respect to a sample disposing space, and the detecting coil detects an alternating current magnetic field generated by the exciting coil. As the exciting coil, this magnetic sensor device is provided with a first exciting coil, which is disposed on one side of the sample disposing space, and a second exciting coil, which is disposed on the other side of the sample disposing space. As the detecting coil, this magnetic sensor device is provided with a first detecting coil, which detects, on the other side of the sample disposing space, an alternating current magnetic field of the first exciting coil, and a second detecting coil, which detects, on the one side of the sample disposing space, an alternating current magnetic field of the second exciting coil.

### CROSS REFERENCE TO RELATED APPLICATIONS

This is the U.S. national stage of application No. PCT/JP2013/0066291 filed on Jun. 13, 2013. Priority under 35 U.S.C. §119(a) and 35 U.S.C. §365(b) is claimed from Japanese Application No. 2012-165314, filed Jul. 26, 2012, the disclosure of which are also incorporated herein by reference.

### FIELD OF THE INVENTION

The present invention relates to a magnetic sensor device for magnetically detecting metal material mixed with an inspection object (an object to be inspected) or metal material applied to an inspection object.

### BACKGROUND

As a device for magnetically detecting metal material which is mixed with an inspection object, a device for magnetically detecting a foreign matter made of metal mixed in food has been proposed (see, for example, Patent Literature 1). In the device described in Patent Literature 1, when an inspection object is passed through an inner side of an exciting coil, change of a magnetic field is detected by a magnetic sensor.

Further, as a device for magnetically detecting metal material applied to an inspection object, a device for magnetically detecting a pattern printed on a bank bill with magnetic ink has been proposed (see, for example, Patent Literatures 2 and 3). In the devices described in Patent Literatures 2 and 3, change of a magnetic field generated by an exciting coil disposed on one side with respect to an inspection object is detected by a detection coil disposed on one side with respect to the inspection object.

### PATENT LITERATURE

[PTL 1] Japanese Patent Laid-Open No. 2004-28955

[PTL 2] Japanese Patent Laid-Open No. 2006-309669

[PTL 3] Japanese Patent Laid-Open No. 2009-163336

However, in a structure in which an inspection object is passed through an inner side of the exciting coil like the device described in Patent Literature 1, the inspection object may be unable to pass through an inner side of the exciting coil depending on a size and a shape of the inspection object. On the other hand, in a structure in which an exciting coil and a detection coil are disposed on one side with respect to an inspection object like the devices described in Patent Literatures 2 and 3, the problem occurred in the device described in Patent Literature 1 does not occur but, depending on a position of an inspection object which is passed how separated from the exciting coil and the detection coil, its detection sensitivity largely varies.

### SUMMARY

In view of the problems described above, at least an embodiment of the present invention provides a magnetic sensor device which is capable of relaxing a variation of sensitivity caused by a position of an inspection object (object to be inspected) even when the inspection object is disposed on a side with respect to an exciting coil and a detection coil.

To achieve the above, at least an embodiment of the present invention provides a magnetic sensor device including an exciting coil, a detection coil which faces the exciting coil and detects an AC magnetic field generated by the exciting coil, and an object arrangement space where an inspection object is disposed between the detection coil and the exciting coil.

In at least an embodiment of the present invention, an exciting coil and a detection coil are disposed with respect to an object arrangement space, and the detection coil detects an AC (alternating current) magnetic field generated by the exciting coil. Therefore, in a case that metal material is mixed with an inspection object or, in a case that metal material is applied to the inspection object, a detected result by the detection coil is varied and thus existence/absence of metal material can be detected. The exciting coil and the detection coil are respectively arranged on opposite sides to each other with the object arrangement space interposing therebetween. Therefore, in a case that an inspection object is located at a position near to the exciting coil in the object arrangement space, the inspection object is located at a position far from the detection coil and, in a case that an inspection object is located at a position far from the exciting coil, the inspection object is located at a position near to the detection coil. Accordingly, variation of sensitivity due to a position of an inspection object in the object arrangement space can be relaxed and thus variation of sensitivity caused by a position of an inspection object can be relaxed.

In at least an embodiment of the present invention, it is preferable that the exciting coil includes a first exciting coil disposed on one side with respect to the object arrangement space and a second exciting coil disposed on the other side with respect to the object arrangement space, and the detection coil includes a first detection coil which detects an AC magnetic field of the first exciting coil on the other side with respect to the object arrangement space and a second detection coil which detects an AC magnetic field of the second exciting coil on the one side with respect to the object arrangement space. According to this structure, even when an inspection object is located at any position in distance from the exciting coil and the detection coil in the object arrangement space, similar sensitivity can be obtained.

In at least an embodiment of the present invention, it is preferable that the first exciting coil and the second exciting coil are driven at times shifted from each other. According to this structure, even when a structure that alternating currents whose frequencies are different from each other are supplied to the first exciting coil and the second exciting coil or the like is not adopted, existence/absence of metal material can be detected on the basis of a result that the first detection coil detects an AC magnetic field of the first exciting coil and a result that the second detection coil detects an AC magnetic field of the second exciting coil.

In at least an embodiment of the present invention, it is preferable that the exciting coil is held by an exciting coil core disposed on one side with respect to the object arrangement space, the detection coil is held by a detection coil core disposed on the other side with respect to the object arrangement space, and the exciting coil core and the detection coil core are magnetically connected with each other. According to this structure, leakage flux can be reduced and thus a high degree of sensitivity can be obtained.

In at least an embodiment of the present invention, it is preferable that the first exciting coil and the second detection coil are held by a first core disposed on the one side with respect to the object arrangement space, the second exciting coil and the first detection coil are held by a second core disposed on the other side with respect to the object arrangement space, and the first core and the second core are magnetically connected with each other. According to this structure, leakage flux can be reduced and thus a high degree of sensitivity can be obtained.

In at least an embodiment of the present invention, it is preferable that the first exciting coil is held by a first exciting coil core disposed on the one side with respect to the object arrangement space, the first detection coil is held by a first detection coil core disposed on the other side with respect to the object arrangement space, the first exciting coil core and the first detection coil core are magnetically connected with each other, the second exciting coil is held by a second exciting coil core disposed on the other side with respect to the object arrangement space, the second detection coil is held by a second detection coil core disposed on the one side with respect to the object arrangement space, and the second exciting coil core and the second detection coil core are magnetically connected with each other. According to this structure, leakage flux can be reduced and thus a high degree of sensitivity can be obtained.

In at least an embodiment of the present invention, a structure may be adopted that each of the exciting coil and the detection coil is an air-core coil. According to this structure, different from a case that a core is used, flexibility for disposing the exciting coil and the detection coil is high.

In at least an embodiment of the present invention, in a case that each of the first exciting coil, the first detection coil, the second exciting coil and the second detection coil is an air-core coil, it is preferable that the first exciting coil is disposed on an opposite side to the object arrangement space with respect to the second detection coil and the second exciting coil is disposed on an opposite side to the object arrangement space with respect to the first detection coil. According to this structure, the exciting coil (first exciting coil and second exciting coil) is located at a position which is separated from the object arrangement space relative to the detection coil (first detection coil and second detection coil) and thus a magnetic field can be generated over the entire object arrangement space.

In at least an embodiment of the present invention, it is preferable that a plurality of the first detection coils is disposed on the other side with respect to the object arrangement space, and a plurality of the second detection coils is disposed on the one side with respect to the object arrangement space. According to this structure, even when the size of an inspection object is large, existence/absence of metal material can be detected. Further, it can be detected which position metal material exists in or on an inspection object.

In this case, it is preferable that the plurality of the first detection coils is linearly disposed along the object arrangement space, and the plurality of the second detection coils is linearly disposed along the object arrangement space. According to this structure, the size of the magnetic sensor device can be reduced, and a plurality of the first detection coils can be respectively disposed at magnetically same positions or at substantially magnetically same positions, and a plurality of the second detection coils can be respectively disposed at magnetically same positions or at substantially magnetically same positions.

In at least an embodiment of the present invention, it is preferable that the plurality of the first detection coils is successively driven at times shifted from each other and the plurality of the second detection coils is successively driven at times shifted from each other. According to this structure, a structure of a processing circuit for signals outputted from the first detection coil and the second detection coil can be simplified.

In at least an embodiment of the present invention, it is preferable that a difference of signals detected by the first detection coils adjacent to each other is outputted from the plurality of the first detection coils, and a difference of signals detected by the second detection coils adjacent to each other is outputted from the plurality of the second detection coils. According to this structure, since a differential between adjacent detection coils is utilized, it is hardly affected by ambient temperature and variation of a drive current and the like.

In at least an embodiment of the present invention, it is preferable that the magnetic sensor device includes a conveying mechanism configured to convey the inspection object to the object arrangement space. According to this structure, an inspection object can be conveyed automatically.

In at least an embodiment of the present invention, the detection coil detects an AC (alternating current) magnetic field generated by the exciting coil and thus, in a case that metal material is mixed with an inspection object or, in a case that metal material is applied to the inspection object, a detected result by the detection coil is varied and thus existence/absence of metal material can be detected. The exciting coil and the detection coil are respectively arranged on opposite sides to each other with the object arrangement space interposing therebetween. Therefore, in a case that an inspection object is located at a position near to the exciting coil in the object arrangement space, the inspection object is located at a position far from the detection coil and, in a case that an inspection object is located at a position far from the exciting coil, the inspection object is located at a position near to the detection coil. Accordingly, variation of sensitivity due to a position of an inspection object in the object arrangement space can be relaxed and thus variation of sensitivity caused by a position of an inspection object can be relaxed.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory view showing an inspection apparatus including a magnetic sensor device in accordance with a first embodiment of the present invention.

FIGS. 2(a) through 2(d) are explanatory views showing a magnetic sensor device in accordance with the first embodiment of the present invention.

FIGS. 3(a) and 3(b) are explanatory views showing a measurement principle in a magnetic sensor in accordance with the first embodiment of the present invention.

FIGS. 4(a) through 4(d) are views for explaining sensitivity of a magnetic sensor in accordance with the first embodiment of the present invention.

FIG. 5 is an explanatory view schematically showing a circuit for successively driving a plurality of detection coils in a magnetic sensor in accordance with the first embodiment of the present invention.

FIG. 6 is an explanatory view schematically showing another circuit for successively driving a plurality of detection coils in a magnetic sensor in accordance with the first embodiment of the present invention.

FIGS. 7(a) through 7(f) are explanatory views showing a magnetic sensor device in accordance with a second embodiment of the present invention.

FIGS. 8(a) through 8(c) are explanatory views showing a magnetic sensor device in accordance with a third embodiment of the present invention.

FIG. 9 is a front view showing a magnetic sensor device in accordance with a fourth embodiment of the present invention.

FIGS. 10(a) and 10(b) are explanatory views showing a magnetic sensor device in accordance with a fifth embodiment of the present invention.

### DESCRIPTION OF EMBODIMENTS

Embodiments to which the present invention is applied will be described below with reference to the accompanying drawings. In the following description, a direction in which an exciting coil and a detection coil face each other is set in a “Z”-axis direction, a direction perpendicular to the “Z”-axis direction is set in an “X”-axis direction, and a direction perpendicular to the “X”-axis direction and the “Z”-axis direction is set in a “Y”-axis direction. Further, the “Z”-axis direction corresponds to a thickness direction of an inspection object, the “X”-axis direction corresponds to a widthwise direction of the inspection object, and the “Y”-axis direction corresponds to a conveying direction of the inspection object.

### First Embodiment

### Entire Structure of Inspection Apparatus

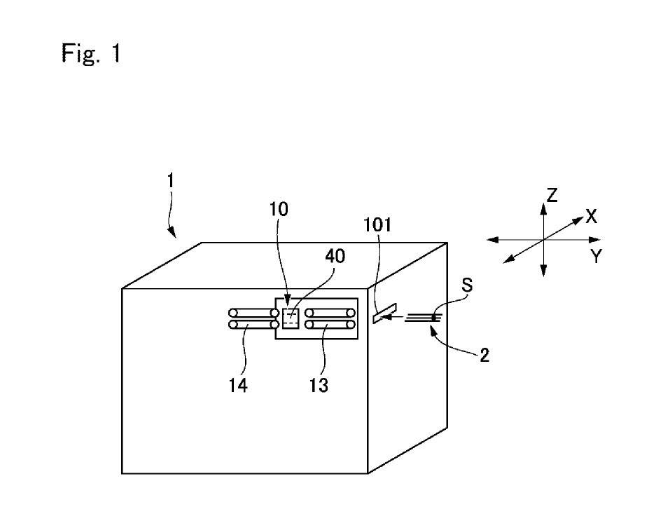

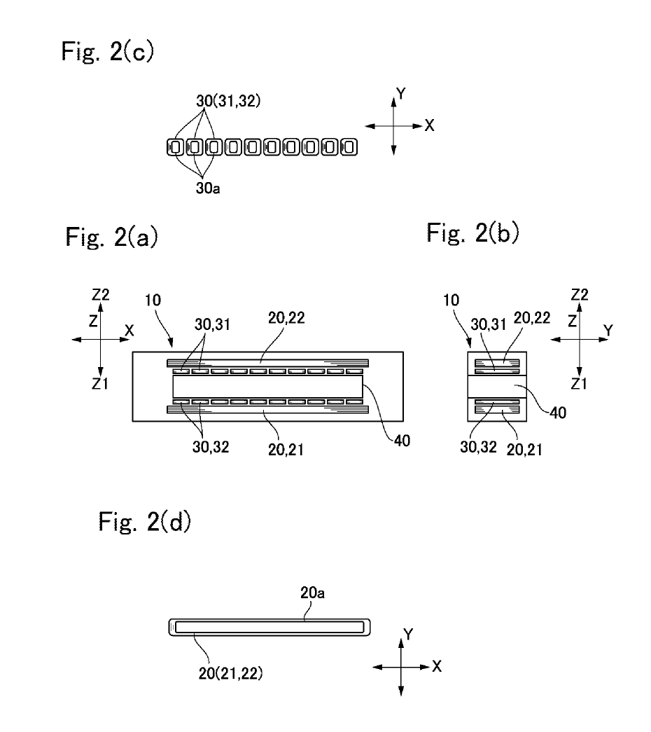

FIG. 1 is an explanatory view showing an inspection apparatus including a magnetic sensor device in accordance with a first embodiment of the present invention. FIGS. 2(a) through 2(d) are explanatory views showing a magnetic sensor device in accordance with the first embodiment of the present invention. FIG. 2(a) is a front view showing a magnetic sensor device, FIG. 2(b) is its side view, FIG. 2(c) is an explanatory view showing detection coils, and FIG. 2(d) is an explanatory view showing an exciting coild.

In FIG. 1, in an ATM apparatus 1 (Automatic Teller Machine) installed in a bank or the like, a magnetic sensor device 10 is mounted which magnetically inspects whether or not a metal foreign matter “S” such as a clip or a staple of a stapler is mixed with one or plural bank bills 2 (inspection object) having been inputted. The magnetic sensor device 10 includes a belt type conveying mechanism 13 for conveying a bank bill 2 in the “Y”-axis direction from an input port 101 to an object arrangement space 40 of the magnetic sensor device 10, and a belt type conveying mechanism 14 for conveying the bank bill 2 in the “Y”-axis direction from the object arrangement space 40 of the magnetic sensor device 10 to a bank bill identifying machine (not shown).

As shown in FIGS. 2(a) through 2(d), the magnetic sensor device 10 includes an exciting coil 20 and a plurality of detection coils 30 which face the exciting coil 20 in the “Z”-axis direction and are linearly arranged in the “X”-axis direction. The object arrangement space 40 where an inspection object such as a bank bill 2 or the like is disposed is structured between the detection coils 30 and the exciting coil 20. In the magnetic sensor device 10, the exciting coil 20 is driven by a drive circuit (not shown) to generate an AC magnetic field and the detection coils 30 detect the AC magnetic field which is generated by the exciting coil 20.

In this embodiment, the exciting coil 20 is comprised of a first exciting coil 21, which is disposed on one side “Z1” in the “Z”-axis direction with respect to the object arrangement space 40, and a second exciting coil 22 which is disposed on the other side “Z2” in the “Z”-axis direction with respect to the object arrangement space 40. The exciting coil 20 (each of the first exciting coil 21 and the second exciting coil 22) is an air-core coil having a rectangular shape whose dimension in a widthwise direction of the object arrangement space 40 (“X”-axis direction) is larger than its dimension in the “Y”-axis direction. An opening part 20a is directed toward a side in the “Z”-axis direction where the object arrangement space 40 is located. The dimension in the “X”-axis direction of the exciting coil 20 (first exciting coil 21 and second exciting coil 22) is slightly larger than the dimension in the widthwise direction (“X”-axis direction) of the object arrangement space 40.

Further, in this embodiment, a plurality of the detection coils 30 is comprised of a plurality of first detection coils 31, which face the first exciting coil 21 so as to interpose the object arrangement space 40 therebetween on the other side “Z2” in the “Z”-axis direction with respect to the object arrangement space 40, and a plurality of second detection coils 32 which face the second exciting coil 22 so as to interpose the object arrangement space 40 therebetween on one side “Z1” in the “Z”-axis direction with respect to the object arrangement space 40. The first detection coils 31 detect an AC magnetic field of the first exciting coil 21 and the second detection coils 32 detect an AC magnetic field of the second exciting coil 22. The detection coil 30 (first detection coil 31 and second detection coil 32) is an air-core coil whose opening part 30a is directed toward a side in the “Z”-axis direction where the object arrangement space 40 is located. The Detection coil 30 has a rectangular shape whose dimension in the “X”-axis direction is substantially equal to a dimension in the “Y”-axis direction. The dimension in the “Y”-axis direction of the detection coil 30 is substantially equal to a dimension in the “Y”-axis direction of the exciting coil 20 and a dimension in the “X”-axis direction of the detection coil 30 is considerably smaller than a dimension in the “X”-axis direction of the exciting coil 20. In this embodiment, a length dimension where ten pieces of the detection coil 30 are arranged in the “X”-axis direction is the same as that of the object arrangement space 40. In other words, the object arrangement space 40 is determined by a range where the detection coils 30 are arranged.

In this embodiment, the first exciting coil 21 is disposed on an opposite side (one side “Z1” in the “Z”-axis direction) to the object arrangement space 40 with respect to a plurality of the second detection coils 32 and the second exciting coil 22 is disposed on an opposite side (the other side “Z2” in the “Z”-axis direction) to the object arrangement space 40 with respect to a plurality of the first detection coils 31. Therefore, the exciting coil 20 (first exciting coil 21 and second exciting coil 22) is located at a separated position from the object arrangement space 40 relative to the detection coils 30 (first detection coils 31 and second detection coils 32).

### (Principle)

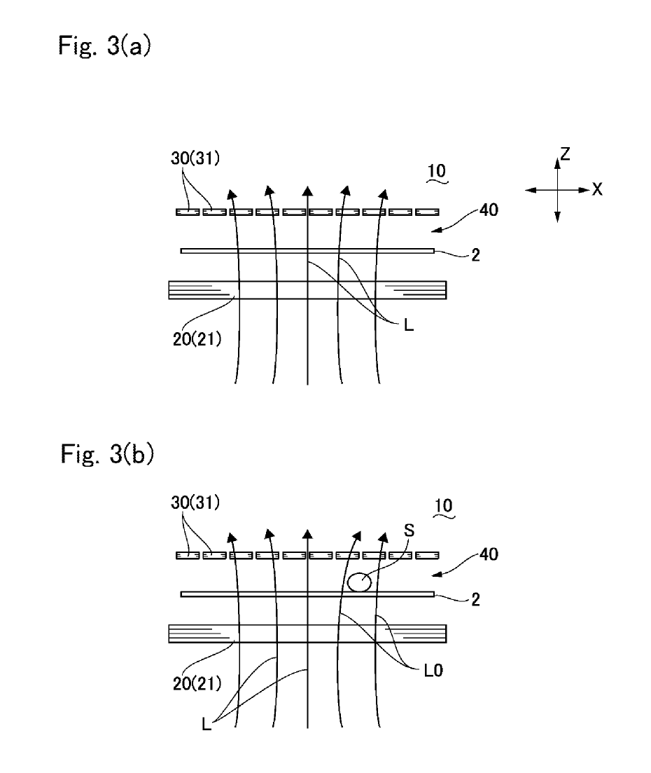

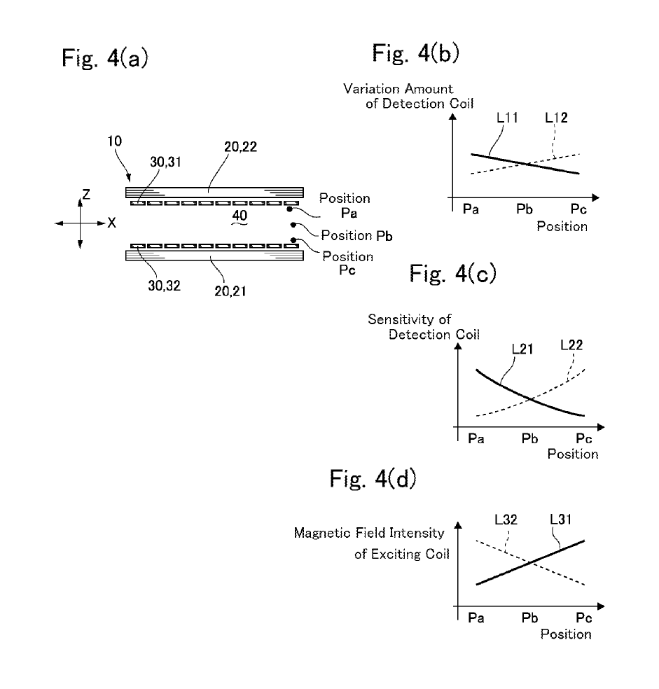

FIGS. 3(a) and 3(b) are explanatory views showing a measurement principle in the magnetic sensor in accordance with the first embodiment of the present invention. FIG. 3(a) is an explanatory view showing a state that a metal foreign matter is not existed and FIG. 3(b) is an explanatory view showing a state that a metal foreign matter is existed. FIGS. 4(a) through 4(d) are views for explaining sensitivity of a magnetic sensor in accordance with the first embodiment of the present invention. FIG. 4(a) is an explanatory view showing positions of an inspection object in the object arrangement space, FIG. 4(b) is an explanatory view schematically showing a position of an inspection object and a variation amount of a detection amount in the detection coil, FIG. 4(c) is an explanatory view schematically showing a relationship between a position of an inspection object and a detected intensity by the detection coil, and FIG. 4(d) is an explanatory view schematically showing a relationship between a position of an inspection object and magnetic field intensity generated by the exciting coil.

As shown in FIG. 3(a), in the magnetic sensor device 10, when an alternating current is supplied to the exciting coil 20 by a drive circuit (not shown), the detection coils 30 detect a magnetic field generated by the exciting coil 20. In this case, when a metal foreign matter “S” is not mixed with a bank bill 2, the magnetic lines “L” draw curved lines such that directions of their tangent lines are coincided with directions of a magnetic field by the exciting coil 20. On the other hand, when a metal foreign matter “S” is mixed with a bank bill 2 as shown in FIG. 3(b), although curved lines are drawn such that directions of tangent lines of the magnetic lines “L” are coincided with the directions of a magnetic field generated by the exciting coil 20 at positions far separated from the metal foreign matter “S”, the magnetic lines “L0” are warped at positions near to the metal foreign matter “S”. Therefore, a detected result is varied in the detection coils 30 located in the vicinity of the metal foreign matter “S” among a plurality of the detection coils 30. For example, in a case that a metal foreign matter “S” is made of magnetic material, magnetic permeability is increased and thus an output level from a detection coil 30 located in the vicinity of the metal foreign matter “S” among a plurality of the detection coils 30 is increased. On the other hand, for example, in a case that a metal foreign matter “S” is made of nonmagnetic material, an output level from the detection coil 30 located in the vicinity of the metal foreign matter “S” is lowered due to an eddy current. Therefore, an inspection circuit (not shown) of the magnetic sensor device 10 is capable of detecting a metal foreign matter “S” which is mixed with a bank bill 2. Accordingly, in the ATM machine 1 shown in FIG. 1, when the magnetic sensor device 10 detects that no metal foreign matter “S” is mixed with a bank bill 2, the belt type conveying mechanism 14 conveys the bank bill 2 having been inputted to a bank bill identification part which is provided in a subsequent stage. On the other hand, in a case that the magnetic sensor device 10 detects that a metal foreign matter “S” is mixed with a bank bill 2, the belt type conveying mechanism 14 does not convey the bank bill 2 having been inputted to the bank bill identification part provided in a subsequent stage but the belt type conveying mechanism 13 returns the bank bill 2 having been inputted to the input port 101. Therefore, a metal foreign matter “S” such as a clip is not conveyed to the bank bill identification part and thus the bank bill identification part does not occur a trouble caused by the metal foreign matter “S”.

In this embodiment, as shown in FIG. 4(a), the exciting coil 20 is disposed on an opposite side to a plurality of the detection coils 30 for detecting an AC magnetic field generated by the exciting coil 20 so as to interpose the object arrangement space 40 therebetween. In other words, the first exciting coil 21 and the first detection coils 31 are disposed on opposite sides to each other across the object arrangement space 40, and the second exciting coil 22 and the second detection coils 32 are disposed on opposite sides to each other across the object arrangement space 40. Therefore, even when a metal foreign matter “S” is existed in any positions “Pa”, “Pb” and “Pc” shown in FIG. 4(a) in a thickness direction (“Z”-axis direction) of the object arrangement space 40, as shown by the solid line “L11” in FIG. 4(b), an appropriate level of a variation amount of an electric current can be detected by the first detection coil 31. Further, even when a metal foreign matter “S” is existed in any positions “Pa”, “Pb” and “Pc” shown in FIG. 4(a) in the thickness direction (“Z”-axis direction) of the object arrangement space 40, as shown by the dotted line “L12” in FIG. 4(b), an appropriate level of a variation amount of an electric current can be detected by the second detection coil 32.

More specifically, as shown by the solid line “L21” in FIG. 4(c), in a case that the first detection coil 31 is located at a position where a distance from a metal foreign matter “S” is close, the first detection coil 31 provides high sensitivity and, as a distance between a metal foreign matter “S” and the first detection coil 31 becomes longer, the sensitivity tends to lower. Therefore, when the magnetic field is constant, the sensitivities of the first detection coil 31 where a metal foreign matter “S” is located at the positions “Pa”, “Pb” and “Pc” satisfy the following relationship:

“Pa”>“Pb”>“Pc”

Further, as shown by the dotted line “L22” in FIG. 4(c), similarly to the first detection coil 31, in a case that the second detection coil 32 is located at a position where a distance from a metal foreign matter “S” is close, the second detection coil 32 also provides high sensitivity and, as a distance between a metal foreign matter “S” and the second detection coil 32 becomes longer, the sensitivity tends to lower. Therefore, when the magnetic field is constant, the sensitivities of the second detection coil 32 where a metal foreign matter “S” is located at the positions “Pa”, “Pb” and “Pc” satisfy the following relationship:

“Pa”<“Ph”<“Pc”

On the other hand, as shown by the solid line “L31” in FIG. 4(d), intensity of a magnetic field generated by the first exciting coil 21 is high at a position near to the first exciting coil 21 and tends to lower as the position is separated from the first exciting coil 21. Therefore, the intensities of the magnetic field at the respective positions “Pa”, “Pb” and “Pc” satisfy the following relationship:

“Pa”<“Ph”<“Pc”

Accordingly, in the magnetic sensor device 10 in this embodiment, output change of the first detection coil 31 is combined with the relationships shown in FIGS. 4(c) and 4(d) each other in a case that a metal foreign matter “S” is located at the positions “Pa”, “Pb” and “Pc” and, as a result, the output change shows a sufficiently high level as shown by the solid line “L11” in FIG. 4(b) even when the metal foreign matter “S” exists in any position of the positions “Pa”, “Pb” and “Pc”. Therefore, the first detection coil 31 is provided with an appropriate sensibility.

On the other hand, as shown by the dotted line “L32” in FIG. 4(d), intensity of a magnetic field generated by the second exciting coil 22 is high at a position near to the second exciting coil 22 and tends to lower as the position is separated from the second exciting coil 22. Therefore, the intensities of the magnetic field at the respective positions “Pa”, “Pb” and “Pc” satisfy the following relationship:

“Pa”>“Pb”>“Pc”

Accordingly, in the magnetic sensor device 10 in this embodiment, output change of the second detection coil 32 is combined with the relationships shown in FIGS. 4(c) and 4(d) each other in a case that a metal foreign matter “S” is located at the positions “Pa”, “Pb” and “Pc” and, as a result, the output change shows a sufficiently high level even when the metal foreign matter “S” exists in any position of the positions “Pa”, “Pb” and “Pc” as shown by the dotted line “L12” in FIG. 4(b). Therefore, the second detection coil 32 is provided with an appropriate sensibility.

Further, as shown by the solid line “L11” in FIG. 4(b), output change of the first detection coil 31 shows a sufficiently high level even when a metal foreign matter “S” is existed at any position of the positions “Pa”, “Pb” and “Pc”. However, in a case that the first detection coil 31 is located at a position near to the metal foreign matter “S”, output change of the first detection coil 31 is large and, as a distance from the metal foreign matter “S” becomes longer, the output change of the first detection coil 31 tends to lower. Therefore, output change of the first detection coil 31 in a case that a metal foreign matter “S” is located at the positions “Pa”, “Pb” and “Pc” shows the following relationship:

“Pa”>“Pb”>“Pc”

On the other hand, as shown by the dotted line “L12” in FIG. 4(b), output change of the second detection coil 32 shows a sufficiently high level even when a metal foreign matter “S” is existed at any position of the positions “Pa”, “Pb” and “Pc”. However, in a case that the second detection coil 32 is located at a position near to the metal foreign matter “S”, output change of the second detection coil 32 is large and, as a distance from the metal foreign matter “S” becomes longer, the output change of the second detection coil 32 tends to lower. Therefore, output change of the second detection coil 32 in a case that a metal foreign matter “S” is located at the positions “Pa”, “Pb” and “Pc” shows the following relationship:

“Pa”<“Ph”<“Pc”

In this embodiment, the exciting coil 20 is comprised of the first exciting coil 21 disposed on one side “Z1” in the “Z”-axis direction with respect to the object arrangement space 40 and the second exciting coil 22 disposed on the other side “Z2” in the “Z”-axis direction with respect to the object arrangement space 40. Further, a plurality of the detection coils 30 is comprised of a plurality of the first detection coils 31 for detecting an AC magnetic field of the first exciting coil 21 on the other side “Z2” in the “Z”-axis direction with respect to the object arrangement space 40 and a plurality of the second detection coils 32 for detecting an AC magnetic field of the second exciting coil 22 on one side “Z1” in the “Z”-axis direction with respect to the object arrangement space 40. Further, in this embodiment, existence/absence of a metal foreign matter “S” is detected on the basis of a detected result of the first detection coil 31 and a detected result of the second detection coil 32. Therefore, even when a metal foreign matter “S” is existed at any position of the positions “Pa”, “Pb” and “Pc”, the magnetic sensor device 10 provides a sufficiently high sensitivity.

### (First Drive Method)

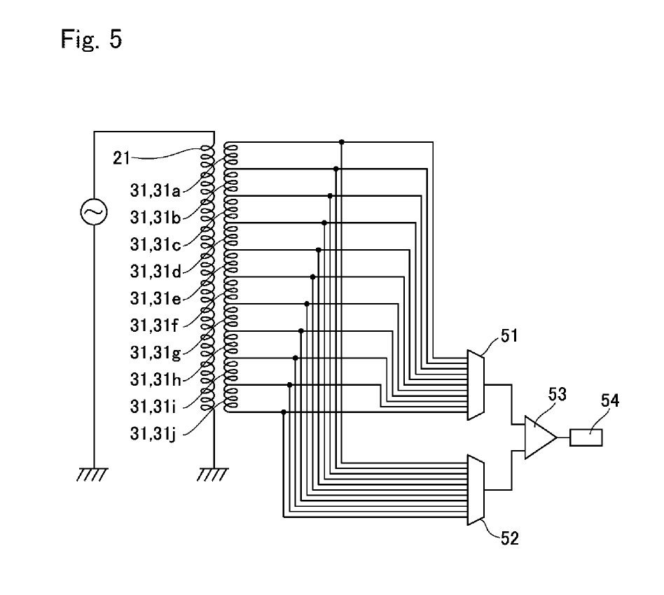

FIG. 5 is an explanatory view schematically showing a circuit for successively driving a plurality of detection coils 30 in the magnetic sensor 10 in accordance with the first embodiment of the present invention.

In this embodiment, the first exciting coil 21 and the second exciting coil 22 are alternately driven at times shifted from each other. Therefore, for example, even when a structure that alternating currents whose frequencies are different from each other are supplied to the first exciting coil 21 and the second exciting coil 22 or the like is not adopted, existence/absence of a metal foreign matter “S” can be detected on the basis of a result that the first detection coil 31 detects an AC magnetic field of the first exciting coil 21 and a result that the second detection coil 32 detects an AC magnetic field of the second exciting coil 22.

Further, a plurality of the detection coils 30 (a plurality of the first detection coils 31 and a plurality of the second detection coils 32) is successively driven. Next, an example that a plurality of the first detection coils 31 is successively driven during a period of time when the first exciting coil 21 is driven will be described below with reference to FIG. 5.

In this embodiment, when a plurality of the first detection coils 31 is referred to as the first detection coils 31a, 31b, 31c, . . . , the first detection coils 31a, 31b, 31c, . . . are connected in series with each other. Further, end parts of the first detection coils 31a, 31b, 31c, . . . are connected with analog switches 51 and 52 such as an analog multiplexer, and outputs of the analog switches 51 and 52 are connected with an operational amplifier 53 for subtraction. According to this structure, during a period of time when the first exciting coil 21 is driven, outputs of the first detection coils 31a, 31b, 31c, . . . are successively inputted into the operational amplifier 53 by the analog switches 51 and 52 and a change of a signal caused by a metal foreign matter “S” is detected.

Further, the second detection coils 32 are also structured similarly to the first detection coils 31 and, during a period of time when the second exciting coil 22 is driven, outputs of the second detection coils 32 are successively inputted into the operational amplifier 53 by the analog switches 51 and 52 and a change of a signal caused by the metal foreign matter “S” is detected.

Therefore, on the basis of an output from the operational amplifier 53 during the period of time when the first exciting coil 21 is driven and an output from the operational amplifier 53 during the period of time when the second exciting coil 22 is driven, an inspection circuit 54 is capable of detecting existence/absence of a metal foreign matter “S” and its position. According to this structure, the inspection circuit 54 can be used in common for a plurality of the first detection coils 31 and the inspection circuit 54 can be used in common for a plurality of the second detection coils 32.

### (Second Drive Method)

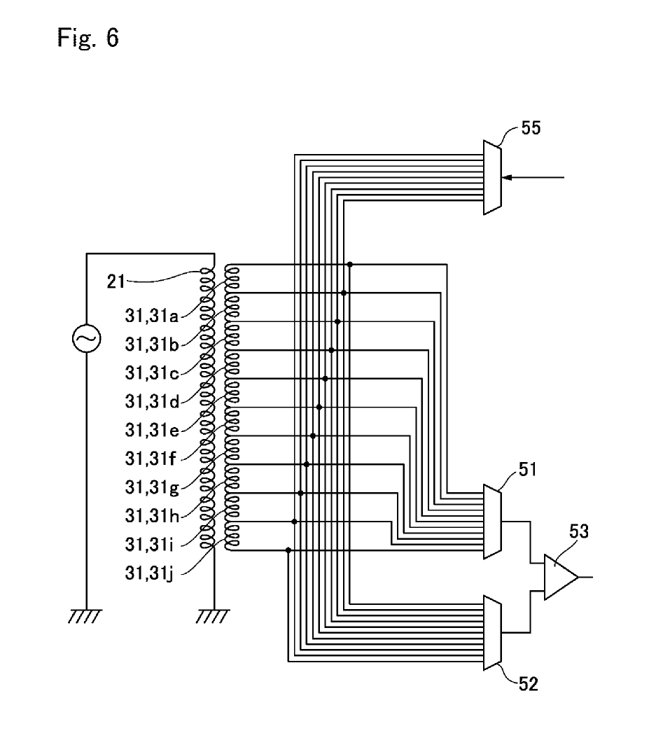

FIG. 6 is an explanatory view schematically showing another circuit for successively driving a plurality of the detection coils 30 in the magnetic sensor device 10 in accordance with the first embodiment of the present invention.

Also in this embodiment, the first exciting coil 21 and the second exciting coil 22 are alternately driven at times shifted from each other. Therefore, for example, even when a structure that alternating currents whose frequencies are different from each other are supplied to the first exciting coil 21 and the second exciting coil 22 or the like is not adopted, existence/absence of a metal foreign matter “S” can be detected on the basis of a result that the first detection coil 31 detects an AC magnetic field of the first exciting coil 21 and a result that the second detection coil 32 detects an AC magnetic field of the second exciting coil 22.

Further, in this embodiment, a plurality of the detection coils 30 (a plurality of the first detection coils 31 and a plurality of the second detection coils 32) is successively driven. In this case, a difference of signals detected by the adjacent first detection coils 31 to each other is successively outputted from a plurality of the first detection coils 31 at times shifted from each other, and a difference of signals detected by the adjacent second detection coils 32 to each other is successively outputted from a plurality of the second detection coils 32 at times shifted from each other. An example that a plurality of the first detection coils 31 is successively driven during a period of time when the first exciting coil 21 is driven will be described below with reference to FIG. 6.

In this embodiment, when a plurality of the first detection coils 31 is referred to as the first detection coils 31a, 31b, 31c, . . . , the first detection coils 31a, 31b, 31c, . . . are connected in series with each other. Further, end parts of the first detection coils 31a, 31b, 31c, . . . are connected with analog switches 51 and 52 such as an analog multiplexer, and outputs of the analog switches 51 and 52 are connected with an operational amplifier 53.

In addition, in the first detection coils 31a, 31b, 31c, . . . , connecting points of the first detection coils 31 adjacent to each other are connected with an analog switch 55 such as an analog demultiplexer.

According to this structure, during a period of time when the first exciting coil 21 is driven, the analog switch 55 successively sets the connecting points of the first detection coils 31 adjacent to each other to ground potential and, in conjunction with this operation, the analog switches 51 and 52 successively input a difference of signals which are detected by the adjacent first detection coils 31 into the operational amplifier 53 and thereby a change of a signal caused by a metal foreign matter “S” is detected. For example, in a case that the analog switch 55 sets the connecting point of the first detection coils 31a and 31b to ground potential, the analog switches 51 and 52 input an output signal from an end part of the first detection coil 31a on an opposite side to the connecting point with the first detection coil 31b into the operational amplifier 53 and an output signal from an end part of the first detection coil 31b on an opposite side to the connecting point with the first detection coil 31a into the operational amplifier 53. Next, for example, in a case that the analog switch 55 sets the connecting point of the first detection coils 31b and 31c to ground potential, the analog switches 51 and 52 input an output signal from an end part of the first detection coil 31b on an opposite side to the connecting point with the first detection coil 31c into the operational amplifier 53 and an output signal from an end part of the first detection coil 31c on an opposite side to the connecting point with the first detection coil 31b into the operational amplifier 53. Then, this switching is performed successively. During that time, the inspection circuit 54 detects existence/absence of a metal foreign matter “S” based on an output from the operational amplifier 53.

Further, the second detection coils 32 are also structured similarly to the first detection coils 31 and, during a period of time when the second exciting coil 22 is driven, analog switches 51, 52 and 55 successively input a difference of signals which are detected by the adjacent second detection coils 32 into an operational amplifier 53 and thereby, an inspection circuit 54 detects existence/absence of a metal foreign matter “S” based on an output from the operational amplifier 53.

According to this structure, the inspection circuit 54 can be used in common for a plurality of the first detection coils 31 and the inspection circuit 54 can be used in common for a plurality of the second detection coils 32. Further, since a differential between adjacent detection coils 30 is utilized, it is hardly affected by ambient temperature and variation of a drive current and the like.

(Principal Effects in this Embodiment)

As described above, in the magnetic sensor device 10 in this embodiment, the exciting coil 20 and the detection coil 30 are disposed with respect to the object arrangement space 40 and the detection coil 30 detects an AC magnetic field generated by the exciting coil 20. Therefore, in a case that a metal foreign matter “S” is mixed with an inspection object such as a bank bill 2, a detected result in the detection coil 30 is varied and thus existence/absence of the metal foreign matter “S” can be detected. In this embodiment, the exciting coil 20 and the detection coil 30 are respectively arranged on opposite sides to each other across the object arrangement space 40. Therefore, in the object arrangement space 40, in a case that an inspection object is located at a position near to the exciting coil 20, the inspection object is located at a position far from the detection coil 30 and, in a case that an inspection object is located at a position far from the exciting coil 20, the inspection object is located at a position near to the detection coil 30. Accordingly, variation of sensitivity due to a position of an inspection object in the object arrangement space 40 can be relaxed and thus the variation of sensitivity caused by a position of the inspection object can be relaxed.

Further, in this embodiment, the first exciting coil 21 disposed on one side with respect to the object arrangement space 40 and the second exciting coil 22 disposed on the other side with respect to the object arrangement space 40 are provided as the exciting coil 20 and, as the detection coil 30, the first detection coil 31 for detecting an AC magnetic field of the first exciting coil 21 is provided on the other side with respect to the object arrangement space 40 and the second detection coil 32 for detecting an AC magnetic field of the second exciting coil 22 is provided on the one side with respect to the object arrangement space 40. Therefore, even when an inspection object is located at any position in distance from the exciting coil 20 and the detection coil 30 in the object arrangement space 40, similar sensitivity can be obtained.

Further, the first exciting coil 21 is disposed on an opposite side to the object arrangement space 40 so as to interpose the second detection coil 32 therebetween, and the second exciting coil 22 is disposed on an opposite side to the object arrangement space 40 so as to interpose the first detection coil 31 therebetween. Therefore, the exciting coil 20 (first exciting coil 21 and second exciting coil 22) is located at a separated position from the object arrangement space 40 relative to a position of the detection coil 30 (first detection coil 31 and second detection coil 32) and thus a magnetic field can be generated over the entire object arrangement space 40.

In addition, the first detection coil 31 and the second detection coil 32 are respectively disposed at plural positions along the object arrangement space 40. Therefore, even when an inspection object such as a bank bill 2 is large, existence/absence of a metal foreign matter “S” can be detected. Further, it can be detected which position a metal foreign matter “S” is existed in an inspection object such as a bank bill 2. Further, the first detection coil 31 and the second detection coil 32 are respectively linearly disposed along the object arrangement space 40 and thus the size of the magnetic sensor device 10 can be reduced. Further, a plurality of the first detection coils 31 can be respectively disposed at magnetically same positions or at substantially magnetically same positions, and a plurality of the second detection coils 32 can be respectively disposed at magnetically same positions or at substantially magnetically same positions. Therefore, it can be easily detected whether a metal foreign matter “S” is existed or not on the basis of detected results of the respective detection coils 30, i.e., a plurality of the first detection coils 31 and a plurality of the second detection coils 32.

Further, in this embodiment, the exciting coil 20 (first exciting coil 21 and second exciting coil 22) and the detection coils 30 (first detection coils 31 and second detection coils 32) are air-core coils. Therefore, different from a case that a core is used, flexibility for disposing the exciting coil 20 and the detection coil 30 can be increased. In accordance with an embodiment of the present invention, a core made of a magnetic body may be disposed on an inner side of the exciting coil 20 (first exciting coil 21 and second exciting coil 22) or on an inner side of the detection coil 30 (first detection coil 31 and second detection coil 32).

### Second Embodiment

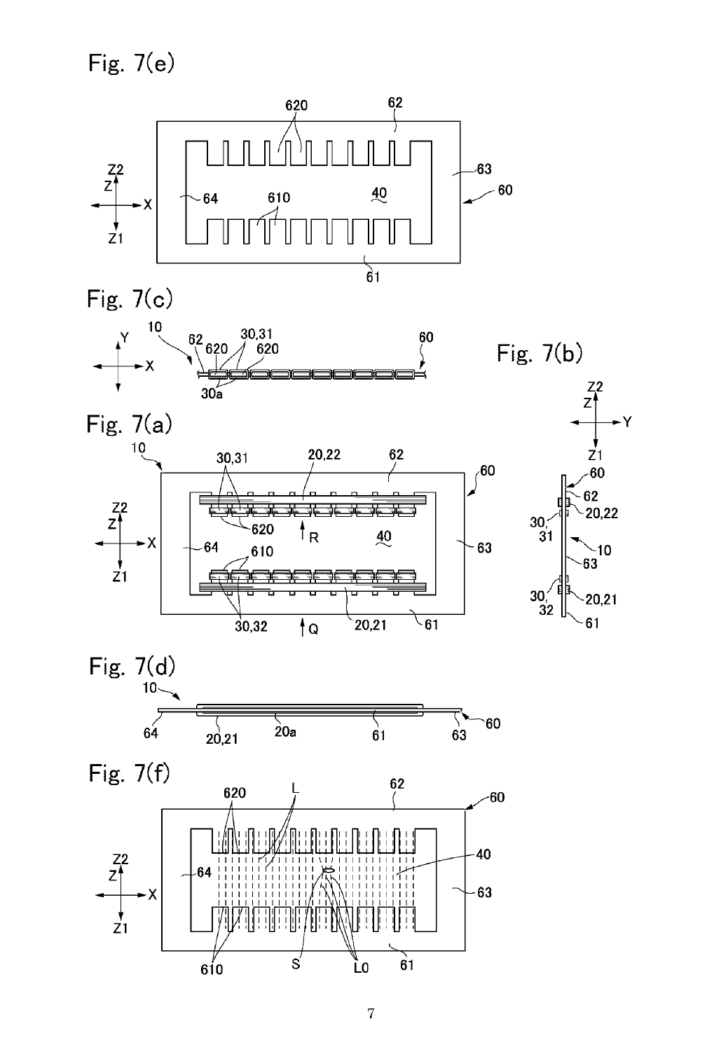

FIGS. 7(a) through 7(f) are explanatory views showing a magnetic sensor device in accordance with a second embodiment of the present invention. FIG. 7(a) is a front view showing a magnetic sensor device, FIG. 7(b) is a side view showing the magnetic sensor device, FIG. 7(c) is an explanatory view showing the magnetic sensor device viewed in a direction of the arrow “R”, FIG. 7(d) is an explanatory view showing the magnetic sensor device viewed in a direction of the arrow “Q”, FIG. 7(e) is a front view showing a core used in the magnetic sensor device, and FIG. 7(f) is an explanatory view schematically showing lines of magnetic force generated in the magnetic sensor device. Basic structures in the second embodiment are similar to the first embodiment and thus the same reference signs are used in common portions and their descriptions are omitted.

As shown in FIGS. 7(a) through 7(f), a magnetic sensor device 10 in the second embodiment also includes, similarly to the first embodiment, an exciting coil 20 and a plurality of detection coils 30 which face the exciting coil 20 in the “Z”-axis direction and are linearly arranged in the “X”-axis direction. An object arrangement space 40 in which an inspection object such as a bank bill 2 shown in FIG. 1 is disposed is structured between the detection coils 30 and the exciting coil 20. Further, as the exciting coil 20, a first exciting coil 21 is disposed on one side “Z1” in the “Z”-axis direction with respect to the object arrangement space 40 and a second exciting coil 22 is disposed on the other side “Z2” in the “Z”-axis direction with respect to the object arrangement space 40. Further, as a plurality of the detection coils 30, a plurality of first detection coils 31 facing the first exciting coil 21 is provided on the other side “Z2” in the “Z”-axis direction with respect to the object arrangement space 40 so as to interpose the object arrangement space 40 therebetween, and a plurality of second detection coils 32 facing the second exciting coil 22 is provided on one side “Z1” in the “Z”-axis direction with respect to the object arrangement space 40 so as to interpose the object arrangement space 40 therebetween. The first detection coils 31 detect an AC magnetic field of the first exciting coil 21 and the second detection coils 32 detect an AC magnetic field of the second exciting coil 22.

In the magnetic sensor device 10 in this embodiment, the first exciting coil 21 and the second detection coils 32 are provided in a first core 610 which is disposed on one side “Z1” in the “Z”-axis direction with respect to the object arrangement space 40, and the second exciting coil 22 and the first detection coils 31 are provided in a second core 620 which is disposed on the other side “Z2” in the “Z”-axis direction with respect to the object arrangement space 40. The first core 610 and the second core 620 are magnetically connected with each other. For example, in this embodiment, the exciting coil 20 (first exciting coil 21 and second exciting coil 22) and the detection coils 30 (first detection coils 31 and second detection coils 32) are wound around a common core 60 which is extended from one side “Z1” to the other side “Z2” in the “Z”-axis direction with respect to the object arrangement space 40.

In this embodiment, the core 60 is formed in a plate shape whose thickness direction is the “Y”-axis direction. The core 60 is formed in a rectangular frame shape provided with a frame part 61, which is extended in the “X”-axis direction on one side “Z1” in the “Z”-axis direction with respect to the object arrangement space 40, a frame part 62 extended in the “X”-axis direction on the other side “Z2” in the “Z”-axis direction with respect to the object arrangement space 40, a frame part 63 which connects one ends in the “X”-axis direction of the frame parts 61 and 62 with each other, and a frame part 64 which connects the other ends in the “X”-axis direction of the frame parts 61 and 62 with each other. Further, the core 60 is formed in a rectangular shape whose long sides are the frame parts 61 and 62 and short sides are the frame parts 63 and 64.

In this embodiment, an edge of the frame part 61 facing the frame part 62 is formed with a plurality of first cores 610 in a salient pole shape which are protruded toward the frame part 62 in the “X”-axis direction, and an edge of the frame part 62 facing the frame part 61 is formed k with a plurality of second cores 620 in a salient pole shape which are protruded toward the frame part 61 in the “X”-axis direction. Further, the first exciting coil 21 is wound around root portions of the first cores 610 located on a frame part 61 side so as to pass through outer sides of the first cores 610 located on both end parts in the “X”-axis direction. The second detection coil 32 is wound around each of a plurality of the first cores 610 in a tip end portion of the first core 610 located on the object arrangement space 40 side. Further, the second exciting coil 22 is wound around root portions of the second cores 620 located on a frame part 62 side so as to pass through outer sides of the second cores 620 located on both end parts in the “X”-axis direction. The first detection coil 31 is wound around each of a plurality of the second cores 620 in a tip end portion of the second core 620 located on the object arrangement space 40 side. Therefore, the first exciting coil 21 is disposed on an opposite side (one side “Z1” in the “Z”-axis direction) to the object arrangement space 40 interposing a plurality of the second detection coils 32 therebetween and the second exciting coil 22 is disposed on an opposite side (the other side “Z2” in the “Z”-axis direction) to the object arrangement space 40 interposing a plurality of the first detection coils 31 therebetween.

Also in the magnetic sensor device 10 structured as described above, similarly to the first embodiment, when an alternating current is supplied to the exciting coil 20 by a drive circuit (not shown), the detection coils 30 detect a magnetic field generated by the exciting coil 20. In this case, the first exciting coil 21 and the second exciting coil 22 are alternately driven at times shifted from each other. Further, a plurality of the first detection coils 31 is successively driven at times shifted from each other and a plurality of the second detection coils 32 is successively driven at times shifted from each other.

In the detection operation, when a metal foreign matter “S” is not mixed with a bank bill 2, the magnetic lines “L” draw curved lines such that directions of their tangent lines are coincided with directions of a magnetic field by the exciting coil 20. On the other hand, when a metal foreign matter “S” is mixed with a bank bill 2, although curved lines are drawn such that directions of tangent lines of the magnetic lines “L” are coincided with the directions of a magnetic field generated by the exciting coil 20 at positions separated from the metal foreign matter “S”, the magnetic lines “L0” are warped at positions near to the metal foreign matter “S”. Therefore, a detected result is varied in the detection coils 30 located in the vicinity of the metal foreign matter “S” among a plurality of the detection coils 30. Accordingly, existence of a metal foreign matter “S” can be detected and effects similar to the first embodiment can be attained.

Further, in this embodiment, the exciting coil 20 and the detection coils 30 are wound around the core 60 and thus leakage flux can be reduced. Therefore, according to this embodiment, a high degree of sensitivity can be obtained and, since leakage flux is hard to affect adjacent detection coils 30, high resolution can be attained.

In accordance with an embodiment of the present invention, the core 60 is not limited to the embodiment shown in FIGS. 7(a) through 7(f). The core 60 may be structured so that the first core 610 and the second core 620 are magnetically connected with each other and that an object arrangement space 40 is provided in a space where the first exciting coil 21 and a plurality of the second detection coils 32 face the second exciting coil 22 and the first detection coils 31. Further, as a structure that the first core 610 and the second core 620 are magnetically connected with each other, it may be structured that the first core 610 and the second core 620 are integrally formed by using one piece of a magnetic body, or that the first core 610 and the second core 620 are connected with each other by using separate magnetic bodies. Alternatively, it may be structured that a magnetic body structuring the first core 610 and a magnetic body structuring the second core 620 are disposed closely to each other and thereby they are magnetically connected with each other.

### Third Embodiment

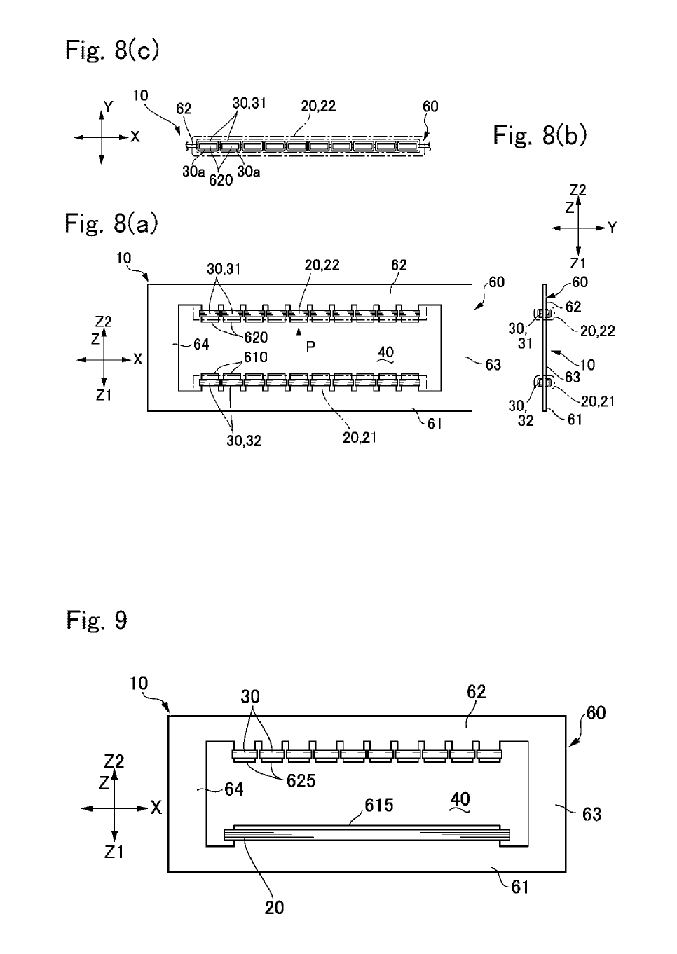

FIGS. 8(a) through 8(c) are explanatory views showing a magnetic sensor device in accordance with a third embodiment of the present invention. FIG. 8(a) is a front view showing a magnetic sensor device, FIG. 8(b) is a side view showing the magnetic sensor device, and FIG. 8(c) is an explanatory view showing the magnetic sensor device which is viewed in a direction shown by the arrow “P”. Basic structures in the third embodiment are similar to the first and the second embodiments and thus the same reference signs are used in common portions and their descriptions are omitted.

As shown in FIGS. 8(a) through 8(c), a magnetic sensor device 10 in the third embodiment also includes, similarly to the first embodiment, an exciting coil 20 and a plurality of detection coils 30 which face the exciting coil 20 in the “Z”-axis direction and are linearly arranged in the “X”-axis direction. An object arrangement space 40 in which an inspection object such as a bank bill 2 shown in FIG. 1 is disposed is structured between the detection coils 30 and the exciting coil 20. Further, as the exciting coil 20, a first exciting coil 21 is disposed on one side “Z1” in the “Z”-axis direction with respect to the object arrangement space 40 and a second exciting coil 22 is disposed on the other side “Z2” in the “Z”-axis direction with respect to the object arrangement space 40. Further, as a plurality of the detection coils 30, a plurality of first detection coils 31 facing the first exciting coil 21 is provided on the other side “Z2” in the “Z”-axis direction with respect to the object arrangement space 40 so as to interpose the object arrangement space 40 therebetween, and a plurality of second detection coils 32 facing the second exciting coil 22 is provided on the one side “Z1” in the “Z”-axis direction with respect to the object arrangement space 40 so as to interpose the object arrangement space 40 therebetween. The first detection coils 31 detect an AC magnetic field of the first exciting coil 21 and the second detection coils 32 detect an AC magnetic field of the second exciting coil 22.

Also in the magnetic sensor device 10 in this embodiment, similarly to the second embodiment, the exciting coil 20 (first exciting coil 21 and second exciting coil 22) and the detection coils 30 (first detection coils 31 and second detection coils 32) are wound around a common core 60 which is extended from one side “Z1” to the other side “Z2” in the “Z”-axis direction with respect to the object arrangement space 40. Also in the core 60, similarly to the first embodiment, an edge of the frame part 61 facing the frame part 62 is formed with a plurality of first cores 610 in a salient pole shape in the “X”-axis direction which are protruded toward the frame part 62, and an edge of the frame part 62 facing the frame part 61 is formed with a plurality of second cores 620 in a salient pole shape which are protruded toward the frame part 61 in the “X”-axis direction.

In this embodiment, in the first core 610, the second detection coil 32 is wound around each of a plurality of the first cores 610 and the first exciting coil 21 is wound around so as to cover the second detection coils 32 and pass through outer sides of the first cores 610 located at both end parts in the “X”-axis direction. Further, in the second core 620, the first detection coil 31 is wound around each of a plurality of the second cores 620 and the second exciting coil 22 is wound around so as to cover the first detection coils 31 and pass through outer sides of the second cores 620 located at both end parts in the “X”-axis direction. In other words, the first exciting coil 21 is wound around so as to surround the second detection coils 32 and the second exciting coil 22 is wound around so as to surround the first detection coils 31.

As described above, also in this embodiment, similarly to the second embodiment, the exciting coil 20 and the detection coils 30 are wound around the common core 60 and thus leakage flux can be reduced. Therefore, according to this embodiment, a high degree of sensitivity can be obtained and, since leakage flux is hard to affect adjacent detection coils 30, high resolution can be attained.

Also in this structure, it may be structured that a magnetic body structuring the first core 610 and a magnetic body structuring the second core 620 are closely disposed to each other and thereby they are magnetically connected with each other.

### Fourth Embodiment

FIG. 9 is a front view showing a magnetic sensor device in accordance with a fourth embodiment of the present invention. Basic structures in the fourth embodiment are similar to the first and the second embodiments and thus the same reference signs are used in common portions and their descriptions are omitted.

As shown in FIG. 9, a magnetic sensor device 10 in the fourth embodiment also includes, similarly to the first embodiment, an exciting coil 20 and a plurality of detection coils 30 which face the exciting coil 20 in the “Z”-axis direction and are linearly arranged in the “X”-axis direction. An object arrangement space 40 in which an inspection object such as a bank bill 2 shown in FIG. 1 is disposed is structured between the detection coils 30 and the exciting coil 20.

In the fourth embodiment, the exciting coil 20 is disposed only on one side “Z1” in the “Z”-axis direction with respect to the object arrangement space 40 and a plurality of the detection coils 30 is provided only at a position facing the exciting coil 20 on the other side “Z2” in the “Z”-axis direction with respect to the object arrangement space 40 so as to interpose the object arrangement space 40 therebetween. The detection coils 30 detect an AC magnetic field of the exciting coil 20.

Also in the magnetic sensor device 10 in this embodiment, similarly to the second and the third embodiments, the exciting coil 20 and the detection coils 30 are wound around a core. More specifically, the exciting coil 20 is held by an exciting coil core 615 which is disposed on one side “Z1” in the “Z”-axis direction with respect to the object arrangement space 40, and the detection coils 30 are held by detection coil cores 625 which are disposed on the other side “Z2” in the “Z”-axis direction with respect to the object arrangement space 40. The exciting coil core 615 and the detection coil cores 625 are magnetically connected with each other. More specifically, the exciting coil 20 and the detection coils 30 are wound around a common core 60 which is extended from one side “Z1” to the other side “Z2” in the “Z”-axis direction with respect to the object arrangement space 40. In this embodiment, in the core 60, an edge of the frame part 61 facing the frame part 62 is formed with an exciting coil core 615 in a salient pole shape which is protruded toward the frame part 62 in the “X”-axis direction. The exciting coil 20 is wound around the exciting coil core 615. Further, an edge of the frame part 62 facing the frame part 61 is formed with a plurality of detection coil cores 625 in a salient pole shape in the “X”-axis direction which are protruded toward the frame part 61. The detection coil 30 is wound around each of a plurality of the detection coil cores 625.

As described above, also in this embodiment, similarly to the second and the third embodiments, the exciting coil 20 and the detection coils 30 are wound around the core 60 and thus leakage flux can be reduced. Therefore, according to this embodiment, a high degree of sensitivity can be obtained and, since leakage flux is hard to affect adjacent detection coils 30, high resolution can be attained.

Also in this structure, it may be structured that a magnetic body structuring the exciting coil core 615 and a magnetic body structuring the detection coil cores 625 are closely disposed to each other and thereby they are magnetically connected with each other.

### Fifth Embodiment

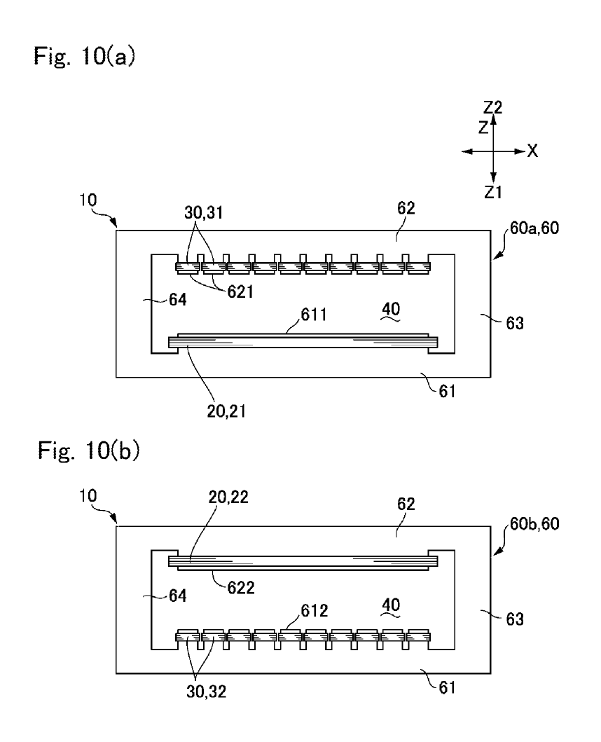

FIGS. 10(a) and 10(b) are explanatory views showing a magnetic sensor device in accordance with a fifth embodiment of the present invention. FIG. 10(a) is a front view showing a core 60a around which a first exciting coil 21 and second detection coils 32 are wound, and FIG. 10(b) is a front view showing a core 60b around which a second exciting coil 22 and first detection coils 31 are wound. Basic structures in the fifth embodiment are similar to the first, the second and the fourth embodiments and the like and thus the same reference signs are used in common portions and their descriptions are omitted.

As shown in FIGS. 10(a) and 10(b), in this embodiment, by utilizing the structure of the magnetic sensor device 10 shown in FIG. 9, the first exciting coil 21 and the second detection coils 32 are disposed on one side “Z1” in the “Z”-axis direction with respect to the object arrangement space 40, and the second exciting coil 22 and the first detection coils 31 are disposed on the other side “Z2” in the “Z”-axis direction. In other words, the core 60 shown in FIG. 9 and the core 60 which is reversed in the “Z”-axis direction with respect to the core 60 shown in FIG. 9 are alternately disposed in the “Y”-axis direction as the cores 60a and 60b.

In this embodiment, in the core 60a shown in FIG. 10(a), an edge of the frame part 61 facing the frame part 62 is formed with a first exciting coil core 611 in a salient pole shape which is protruded toward the frame part 62 in the “X”-axis direction. A first exciting coil 21 is wound around the first exciting coil core 611. Further, an edge of the frame part 62 facing the frame part 61 is formed with a plurality of first detection coil cores 621 in a salient pole shape which are protruded toward the frame part 61 in the “X”-axis direction. A first detection coil 31 is wound around each of a plurality of the first detection coil cores 621.

The core 60b shown in FIG. 10(b) is oppositely disposed to the core 60a in the “Y”-axis direction. In the core 60b, an edge of the frame part 62 facing the frame part 61 is formed with a second exciting coil core 622 in a salient pole shape which is protruded toward the frame part 61, and a second exciting coil 22 is wound around the second exciting coil core 622. Further, an edge of the frame part 61 facing the frame part 62 is formed with a plurality of second detection coil cores 612 in a salient pole shape in the “X”-axis direction which are protruded toward the frame part 62, and a second detection coil 32 is wound around each of a plurality of the second detection coil cores 612.

Also in this structure, it may be structured that a magnetic body structuring the first exciting coil core 611 and a magnetic body structuring the first detection coil cores 621 are disposed closely to each other and thereby they are magnetically connected with each other, and that a magnetic body structuring the second exciting coil core 622 and a magnetic body structuring the second detection coil cores 612 are disposed closely to each other and thereby they are magnetically connected with each other.

### OTHER EMBODIMENTS

In the embodiments described above, a plurality of the first detection coils 31 and a plurality of the second detection coils 32 are provided. However, a structure may be adopted that one piece of the first detection coil 31 and one piece of the second detection coil 32 are provided. Further, in the embodiments described above, as an example, a metal foreign matter “S” is detected. However, at least an embodiment of the present invention may be applied to a magnetic sensor device 10 in which metal material such as magnetic ink applied to an inspection object is detected. Further, metal material such as a metal foreign matter “S” may be detected on the basis of respective signals which are detected by the first detection coil 31 and the second detection coil 32. However, metal material such as a metal foreign matter “S” may be detected on the basis of the sum of respective detected results of the first detection coil 31 and the second detection coil 32 which are oppositely disposed to each other in the “Z”-axis direction.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A magnetic sensor device for use with an inspection object, the magnetic sensor comprising:
an exciting coil;
a detection coil which faces the exciting coil and is structured to detect an AC magnetic field generated by the exciting coil; and
an object arrangement space where the inspection object is disposed between the detection coil and the exciting coil.

2. The magnetic sensor device according to claim 1, wherein
the exciting coil comprises a first exciting coil disposed on one side with respect to the object arrangement space and a second exciting coil disposed on the other side with respect to the object arrangement space, and
the detection coil comprises a first detection coil structured to detect an AC magnetic field of the first exciting coil on the other side with respect to the object arrangement space and a second detection coil structured to detect an AC magnetic field of the second exciting coil on the one side with respect to the object arrangement space.

3. The magnetic sensor device according to claim 2, wherein the first exciting coil and the second exciting coil are driven at times shifted from each other.

4. The magnetic sensor device according to claim 1, wherein
the exciting coil is held by an exciting coil core disposed on one side with respect to the object arrangement space,
the detection coil is held by a detection coil core disposed on the other side with respect to the object arrangement space, and
the exciting coil core and the detection coil core are magnetically connected with each other.

5. The magnetic sensor device according to claim 2, wherein
the first exciting coil and the second detection coil are held by a first core disposed on the one side with respect to the object arrangement space,
the second exciting coil and the first detection coil are held by a second core disposed on the other side with respect to the object arrangement space, and
the first core and the second core are magnetically connected with each other.

6. The magnetic sensor device according to claim 2, wherein
the first exciting coil is held by a first exciting coil core disposed on the one side with respect to the object arrangement space,
the first detection coil is held by a first detection coil core disposed on the other side with respect to the object arrangement space,
the first exciting coil core and the first detection coil core are magnetically connected with each other,
the second exciting coil is held by a second exciting coil core disposed on the other side with respect to the object arrangement space,
the second detection coil is held by a second detection coil core disposed on the one side with respect to the object arrangement space, and
the second exciting coil core and the second detection coil core are magnetically connected with each other.

7. The magnetic sensor device according to claim 1, wherein each of the exciting coil and the detection coil is an air-core coil.

8. The magnetic sensor device according to claim 2, wherein
each of the first exciting coil, the first detection coil, the second exciting coil and the second detection coil is an air-core coil,
the first exciting coil is disposed on an opposite side to the object arrangement space with respect to the second detection coil, and
the second exciting coil is disposed on an opposite side to the object arrangement space with respect to the first detection coil.

9. The magnetic sensor device according to claim 2, wherein
a plurality of the first detection coils is disposed on the other side with respect to the object arrangement space, and
a plurality of the second detection coils is disposed on the one side with respect to the object arrangement space.

10. The magnetic sensor device according to claim 9, wherein
the plurality of the first detection coils is linearly disposed along the object arrangement space, and
the plurality of the second detection coils is linearly disposed along the object arrangement space.

11. The magnetic sensor device according to claim 9, wherein
the plurality of the first detection coils is successively driven at times shifted from each other, and
the plurality of the second detection coils is successively driven at times shifted from each other.

12. The magnetic sensor device according to claim 9, wherein
a difference of signals detected by the first detection coils adjacent to each other is outputted from the plurality of the first detection coils, and
a difference of signals detected by the second detection coils adjacent to each other is outputted from the plurality of the second detection coils.

13. The magnetic sensor device according to claim 1, further comprising a conveying mechanism configured to convey the inspection object to the object arrangement space.

14. The magnetic sensor device according to claim 2, wherein
a plurality of the first detection coils is disposed on the other side with respect to the object arrangement space,
a plurality of the second detection coils is disposed on the one side with respect to the object arrangement space,
the plurality of the first detection coils and the plurality of the second detection coils are disposed in a direction perpendicular to a passing direction of the inspection object.

15. The magnetic sensor device according to claim 14, wherein
the first exciting coil is disposed on an opposite side to the object arrangement space with respect to the second detection coils,
the second exciting coil is disposed on an opposite side to the object arrangement space with respect to the first detection coils, and
the plurality of the first detection coils is successively driven at times shifted from each other during a time period when the first exciting coil is driven, and the plurality of the second detection coils is successively driven at times shifted from each other during a time period when the second exciting coil is driven, the second exciting coil being driven at a time shifted from the first exciting coil, and thereby it is inspected whether a metal foreign matter is mixed with an inspection object or not.

16. The magnetic sensor device according to claim 4, wherein
the inspection object is capable of passing between the exciting coil core and the detection coil core,
the exciting coil is wound around the exciting coil core which is formed in a salient pole shape so as to protrude toward the object arrangement space,
the detection coil is wound around each of a plurality of the detection coil cores which are formed in a salient pole shape so as to protrude toward the object arrangement space, and
a plurality of the detection coils is adjacently disposed to each other in a direction perpendicular to a passing direction of the inspection object.

17. The magnetic sensor device according to claim 5, wherein
a plurality of the first detection coils is linearly disposed along the object arrangement space on the other side with respect to the object arrangement space, and
a plurality of the second detection coils is linearly disposed along the object arrangement space on the one side with respect to the object arrangement space.

18. The magnetic sensor device according to claim 17, wherein
the plurality of the first detection coils is successively driven at times shifted from each other during a time period when the first exciting coil is driven, and
the plurality of the second detection coils is successively driven at times shifted from each other during a time period when the second exciting coil is driven.

19. The magnetic sensor device according to claim 18, wherein
a difference of signals detected by the first detection coils adjacent to each other is outputted from the plurality of the first detection coils, and
a difference of signals detected by the second detection coils adjacent to each other is outputted from the plurality of the second detection coils.

20. The magnetic sensor device according to claim 6, wherein
a plurality of the first detection coils is linearly disposed along the object arrangement space on the other side with respect to the object arrangement space, and
a plurality of the second detection coils is linearly disposed along the object arrangement space on the one side with respect to the object arrangement space.

21. The magnetic sensor device according to claim 20, wherein
the plurality of the first detection coils is successively driven at times shifted from each other during a time period when the first exciting coil is driven, and
the plurality of the second detection coils is successively driven at times shifted from each other during a time period when the second exciting coil is driven.

22. The magnetic sensor device according to claim 21, wherein
a difference of signals detected by the first detection coils adjacent to each other is outputted from the plurality of the first detection coils, and
a difference of signals detected by the second detection coils adjacent to each other is outputted from the plurality of the second detection coils.

23. The magnetic sensor device according to claim 7, wherein
a plurality of the detection coils is disposed for the object arrangement space,
the exciting coil and the plurality of the detection coils are disposed so that the inspection object is passed between the exciting coil and the plurality of the detection coils, and
the plurality of the detection coils is adjacently disposed to each other in a direction perpendicular to a passing direction of the inspection object.
